(19) United States
(12) Patent Application Publication
(10) Pub. No.: US 2025/0196682 A1
(43) Pub. Date: Jun. 19, 2025

(54) Apparatus for Charging Station Construction

(71) Applicant: Windemuller Electric, Inc., Wayland, MI (US)

(72) Inventors: Jeff Robertson, Lawton, MI (US); Brad Erbes, Kent City, MI (US); Matt Wolgamott, Kewadin, MI (US); Scot DeYoung, Grandville, MI (US); Steve Alles, Dorr, MI (US); Eric Fetterley, Brohman, MI (US)

(21) Appl. No.: 18/976,818

(22) Filed: Dec. 11, 2024

Related U.S. Application Data
(60) Provisional application No. 63/609,519, filed on Dec. 13, 2023.

(51) Int. Cl. B60L 53/31

(52) U.S. Cl. CPC B60L 53/31

(57) ABSTRACT

An apparatus for constructing a charging station includes a first wall, a second wall, a first beam, a grid, a bracket, a first conduit, a first leg assembly, and a second leg assembly. The second wall is opposite the first wall. The first beam is coupled to the first wall and the second wall. The grid is supported by the first beam. The bracket is coupled to the first beam and defines a first aperture. The first conduit extends through the first aperture. The first leg assembly is coupled to the first wall or the grid and includes a first leg and a first foot translatably-coupled to the first leg. The second leg assembly is coupled to the second wall or the grid.

### CROSS-REFERENCE TO RELATED APPLICATIONS

This application claims the benefit of U.S. Provisional Application No. 63/609,519 filed Dec. 13, 2023, the entire disclosure of which is incorporated by reference.

### FIELD

This disclosure relates generally to an apparatus for constructing a charging station.

### BACKGROUND

This section provides background information related to the present disclosure and is not necessarily prior art. Electric vehicles (“EVs”) have gained traction and popularity in the automotive industry due in part to their environmentally-friendly nature and reduced dependence on fossil fuels. As a result of this popularity, automakers and governments around the world are encouraging the transition to electric vehicles. The development and construction of a network of EV charging stations is critically important to the speed and success of this transition. Traditional charging station construction systems and methods have limitations relative to installation speed, scalability, and adaptability that often lead to long deployment and construction timelines and increased costs. Moreover, known charging station construction systems and methods may not quickly and efficiently adapt to rapidly evolving EV technology and market demands. Addressing these challenges requires an improved approach to constructing EV charging stations.

While known systems and methods for constructing EV charging stations may be acceptable for their intended purposes, there exists a continuous need in the pertinent art for an improved system and method for constructing EV charging stations that is cost-effective and scalable.

### SUMMARY

This section provides a general summary of the disclosure, and is not a comprehensive disclosure of its full scope or all of its features.

One aspect of the disclosure provides an apparatus for constructing a charging station. The apparatus includes a first wall, a second wall, a first beam, a grid, a bracket, a first conduit, a first leg assembly, and a second leg assembly. The second wall is opposite the first wall. The first beam is coupled to the first wall and the second wall. The grid is supported by the first beam. The bracket is coupled to the first beam and defines a first aperture. The first conduit extends through the first aperture. The first leg assembly is coupled to the first wall or the grid and includes a first leg and a first foot translatably-coupled to the first leg. The second leg assembly is coupled to the second wall or the grid.

Another aspect of the disclosure provides an apparatus for constructing a charging station. The apparatus includes a housing, a first beam, a grid, a bracket, a first conduit, a first leg assembly, and a second leg assembly. The housing includes a first wall and a second wall coupled to the first wall. The first beam is coupled to the first wall. The grid is supported by the first beam. The bracket is coupled to the first beam and defines a first aperture. The first conduit extends through the first aperture. The first leg assembly is coupled to the first wall or the grid and includes a first leg and a first foot translatably-coupled to the first leg. The second leg assembly is coupled to the second wall or the grid.

The details of one or more implementations of the disclosure are set forth in the accompanying drawings and the description below. Other aspects, features, and advantages will be apparent from the description and drawings, and from the claims.

### DESCRIPTION OF DRAWINGS

The drawings described herein are for illustrative purposes only of selected configurations and not all possible implementations, and are not intended to limit the scope of the present disclosure.

FIG. 1 is a perspective view of an apparatus for constructing a charging station in an installation environment according to the principles of the present disclosure.

FIG. 2 is a perspective view of the apparatus of FIG. 1.

FIG. 3 is a top view of the apparatus of FIG. 1.

FIG. 4 is a rear view of the apparatus of FIG. 1.

FIG. 5 is a perspective view of another apparatus for constructing a charging station according to the principles of the present disclosure.

FIG. 6 is a top view of the apparatus of FIG. 5.

FIG. 7 is a perspective view of another apparatus for constructing a charging station in an installation environment according to the principles of the present disclosure.

FIG. 8 is a top view of the apparatus of FIG. 7.

Like reference symbols in the various drawings indicate like elements.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

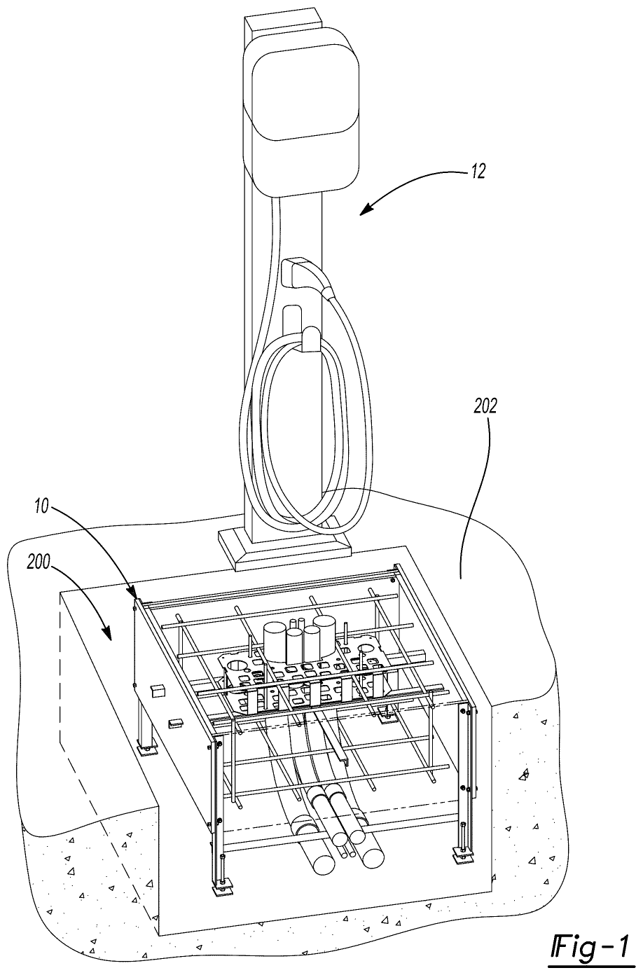

Referring to FIG. 1, a charging station installation assembly 10 for constructing and/or installing a charging station 12 is illustrated. As will be explained in more detail below, the assembly 10 may be used to construct and/or install an electric charging station 12, and related infrastructure, for electric vehicles (“EVs”) such as automobiles and other equipment. As will be further explained in more detail below, in some implementations, the assembly 10 is used to install a series (e.g., more than one) of electric charging stations 12.

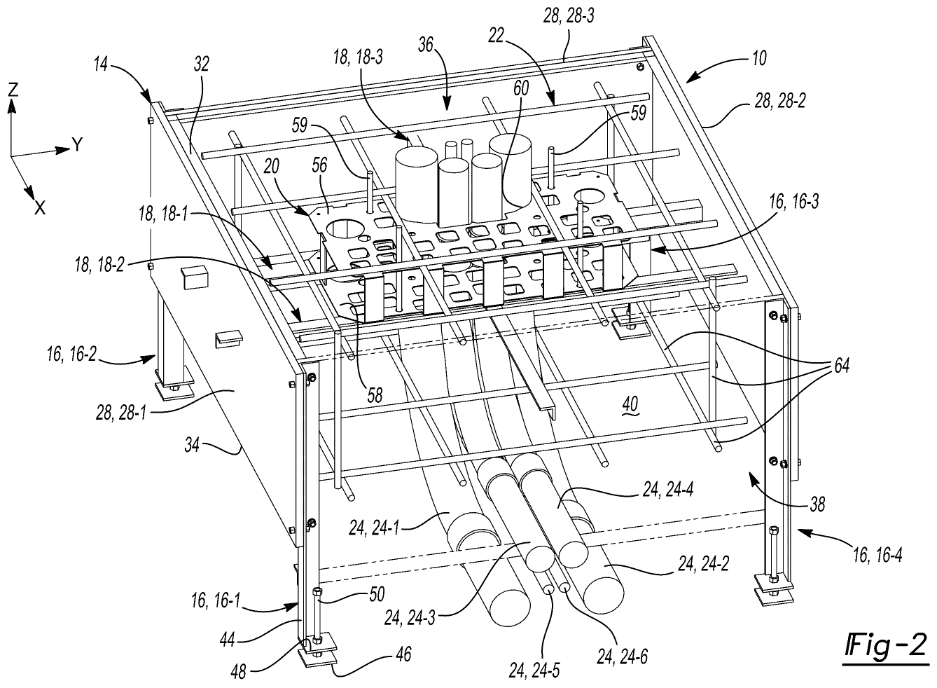

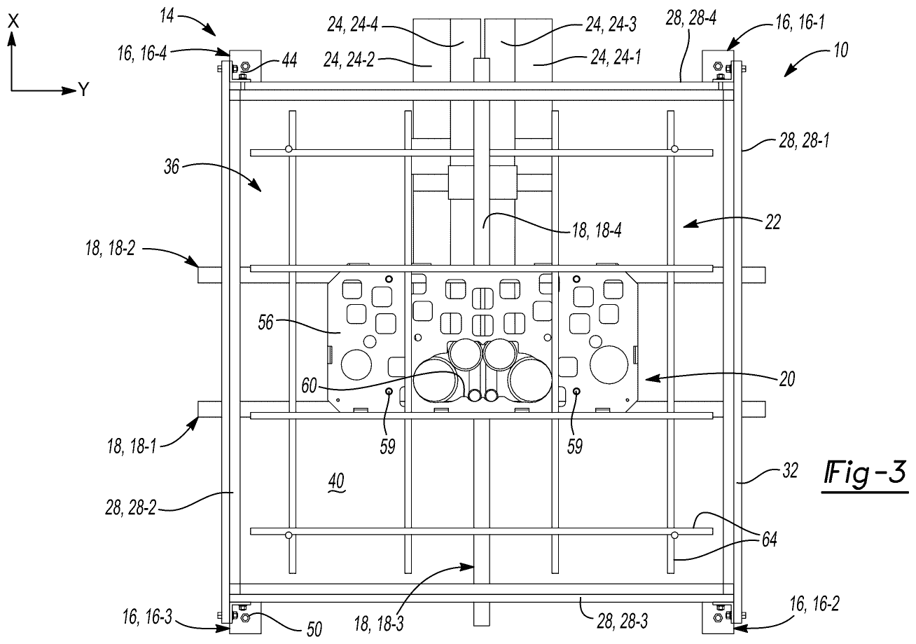

As illustrated in FIGS. 2-4, the assembly 10 may include a housing 14, a plurality of leg assemblies 16, one or more beams 18, a bracket 20, a grid 22, and one or more conduits 24. The housing 14 may include a plurality of walls 28. For example, in some implementations, the housing 14 includes a first wall 28-1, a second wall 28-2, a third wall 28-3, and a fourth wall 28-4. The first wall 28-1 may be opposite the second wall 28-2. In some implementations, the first wall 28-1 and the second wall 28-2 extend in a first direction X such that the first wall is substantially (e.g., +/−10 degrees) parallel to the second wall. The third wall 28-3 and the fourth wall 28-4 may each extend in a second direction Y between the first wall 28-1 and the second wall 28-2. In some implementations, the second direction Y is substantially (e.g., +/−10 degrees) perpendicular to the first direction X such that the third wall 28-3 is substantially parallel to the fourth wall 28-4.

While the housing 14 is generally shown and described as including four walls 28, it will be appreciated that the housing 14 may include less than four walls 28 within the scope of the present disclosure. Each wall 28 may extend in a third direction Z from an upper edge 32 to a lower edge 34 opposite the upper edge 32, such that the upper edges 32 of the walls 28 collectively define an upper opening 36, and the lower edges 34 collectively define a lower opening 38. In some implementations, the third direction Z is substantially (e.g., +/−10 degrees) perpendicular to the first direction X and the second direction Y such that the walls 28 substantially define a rectangular cylinder defining a chamber 40 in fluid communication with the upper opening 36 and the lower opening 38. In this regard, the first wall 28-1 and the second wall 28-2 may each be coupled to the third wall 28-4 and the fourth wall 28-3, such that the walls 28 surround the chamber 40.

In some implementations, the assembly 10 includes four leg assemblies 16. For example, the assembly 10 may include a first leg assembly 16-1, a second leg assembly 16-2, a third leg assembly 16-3, and a fourth leg assembly 16-4. The first leg assembly 16-1 may be coupled to the first wall 28-1 and/or the fourth wall 28-4. The second leg assembly 16-2 may be coupled to the first wall 28-1 and/or the third wall 28-3. The third leg assembly 16-3 may be coupled to the second wall 28-2 and/or the third wall 28-3. The fourth leg assembly 16-4 may be coupled to the second wall 28-2 and/or the fourth wall 28-4. As illustrated, in some implementations, the leg assemblies 16 are disposed at corners of the housing 14.

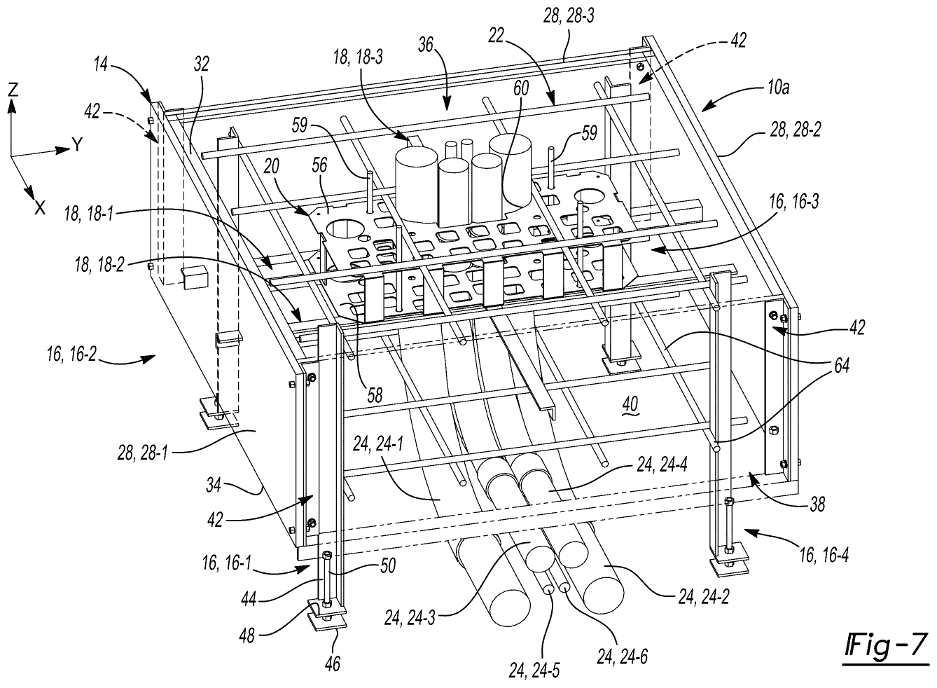

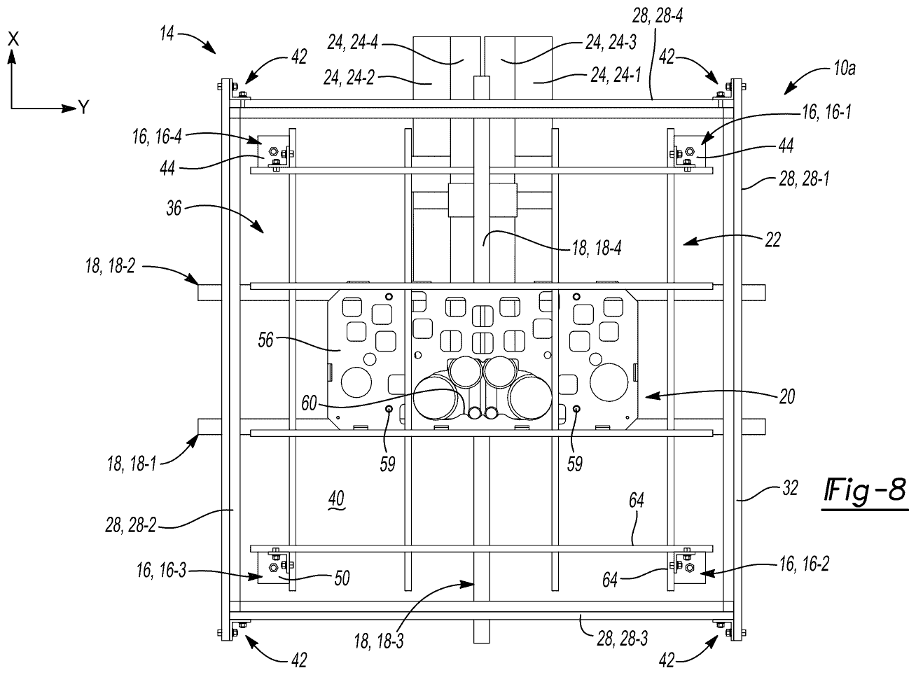

Alternatively, the first leg assembly 16-1, the second leg assembly 16-2, the third leg assembly 16-3, and/or the fourth leg assembly 16-4 may be coupled to the grid 22, and brackets 42 may be disposed at corners of the housing 14 (see, e.g., assembly 10a in FIGS. 7 and 8). In particular, the leg assemblies 16 may be disposed at corners of the grid 22, and the brackets 42 may be coupled to adjacent walls 28 of the housing 14.

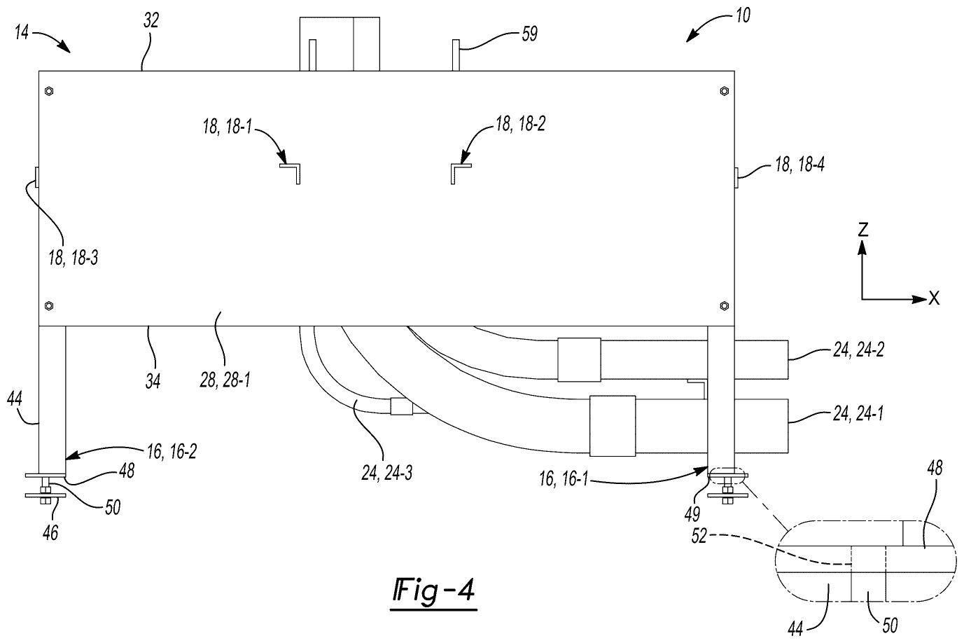

Each leg assembly 16 may include a leg 44, a foot 46, a plate 48, and a connector 50. In some implementations, each leg 44 is fastened (e.g., bolt, screw, adhesive, etc.) to one or more of the walls 28 such that the lower edge 34 of the walls 28 is disposed between the upper edge 32 of the walls 28 and a lower end 49 of the leg 44. The plate 48 may be coupled to lower end 49 of the leg 44 and define an aperture 52 (FIG. 4).

In some implementations, the foot 46 is translatably-coupled to the leg 44 such that the foot 46 can move in the third direction Z relative to the leg 44. For example, the connector 50 may be a rod-like member translatably-disposed within the aperture 52 and coupled to the foot 46. In some implementations, the connector 50 includes a threaded bolt coupled to the leg 44 (e.g., the plate 48) through a threaded engagement within the aperture 52, such that rotation of the connector 50 relative to the leg 44 causes the foot 46 to translate in the third direction Z relative to the leg 44. In some implementations, the connector 50 is rotatably coupled to the foot 46 such that the connector 50 is rotatable relative to the foot 46 and the leg 44.

In some implementations, the assembly 10 includes four beams 18-1, 18-2, 18-3, 18-4. A first beam 18-1 and a second beam 18-2 may extend between the first wall 28-1 and/or the second wall 28-2. In some implementations, the first and second beams 18-1, 18-2 extend in the second direction Y and are coupled to the first and second walls 28-1, 28-2. A third beam 18-3 may extend in the first direction X and be coupled to the third wall 28-3, and a fourth beam 18-4 may extend in the first direction X and be coupled to the fourth wall 28-4.

The bracket 20 may be disposed within the chamber 40 and include a first plate 56, a second plate 58, and one or more supports 59. The second plate 58 may oppose the first plate 56 such that the first and second plates 56, 58 are disposed in a substantially parallel relationship extending in the first and second directions X, Y and separated from one another in the third direction Z. In this regard, the supports 59 (e.g., legs) may extend in the third direction Z and be coupled to the first and second plates 56, 58 to maintain the separation therebetween and to support the charging station 12. For example, in some implementations, the supports 59 include a threaded rod that is coupled to the charging station 12. Each of the first and second plates 56, 58 may define one or more apertures 60 therethrough.

The bracket 20 may be coupled to one or more of the beams 18 (e.g., the first, second, third, and/or fourth beams 18-1, 18-2, 18-3, 18-4). In some implementations, the bracket 20 may be movably (e.g., translatably) coupled to one or more of the beams 18 such that a location of the bracket 20 within the chamber 40 can be changed by moving (e.g., sliding) the bracket 20 relative to the beams 18.

The grid 22 may be disposed within the chamber 40 and include one or more frame members 64 (e.g., wires, rods, etc.). As illustrated, one or more of the frame members 64 may extend in each of the first, second, and/or third directions X, Y, Z. In some implementations, the grid 22 (e.g., one or more of the frame members 64) is coupled to one or more of the beams 18 (e.g., the first, second, third, and/or fourth beams 18-1, 18-2, 18-3, 18-4) and/or the bracket 20. In particular, the grid 22 may be coupled to the bracket 20 such that a location of the bracket 20 within the chamber 40 can be changed by moving (e.g., sliding) the grid 22 and the bracket 20 relative to the beams 18

In some implementations, the assembly 10 includes six conduits 24-1, 24-2, 24-3, 24-4, 24-5, 24-6. As illustrated, the conduits 24 may extend (i) between (relative to the third direction Z) the foot 46 and the lower edge 34 of the walls 28, (ii) through the chamber 40 and the aperture(s) 60, and (iii) through the upper opening 36. As will be explained in more detail below, during installation of the assembly 10, wires (not shown) and cables for transmitting electricity, signals, etc. may be routed through the conduits 24 to the charging station 12.

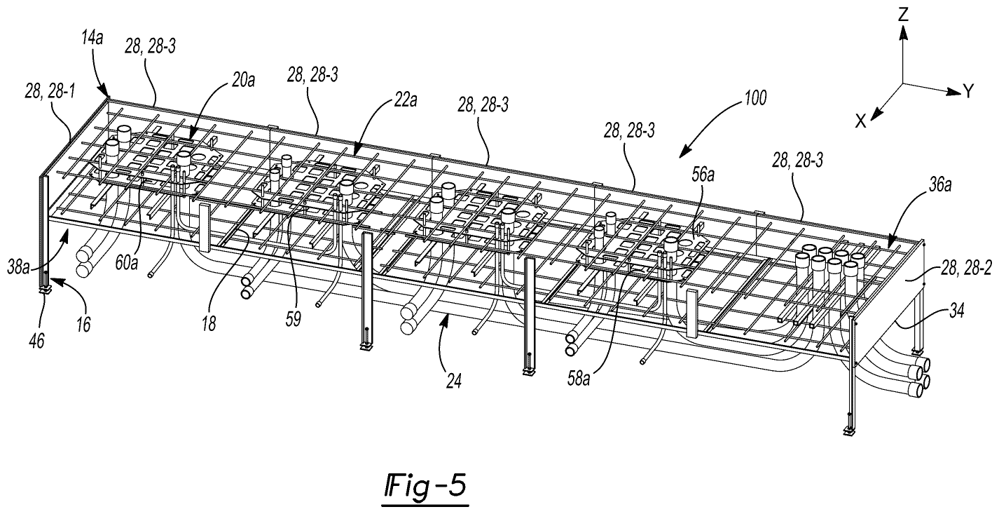

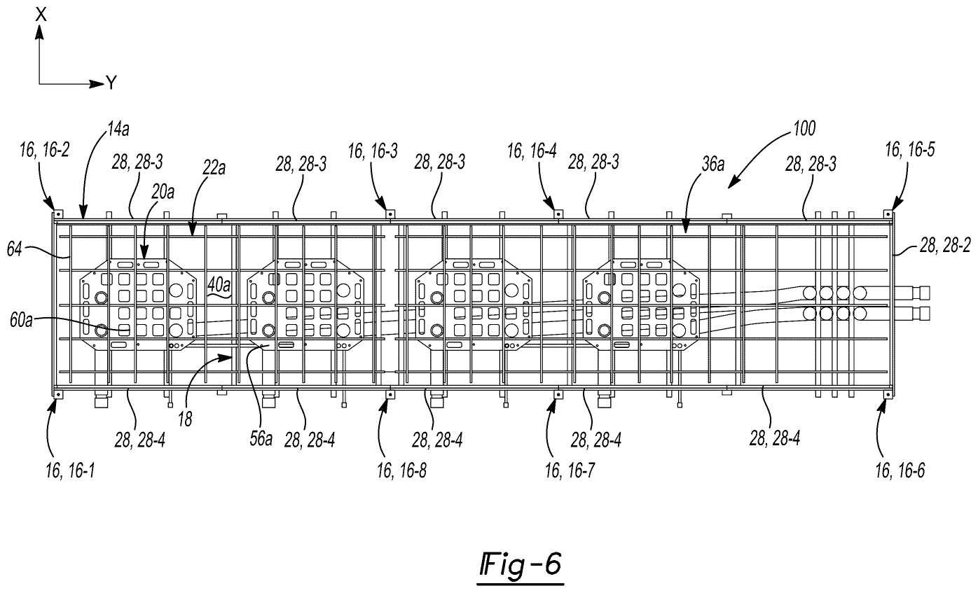

Referring now to FIGS. 5-6, another charging station installation assembly 100 for constructing and/or installing a charging station (e.g., charging station 12) is illustrated. In view of the similarity in structure and function of the assembly 10 to the assembly 100, like reference numerals are used hereinafter and in the drawings to identify like components while like reference numerals containing letter extensions (e.g., “a”) are used to identify those components that have been modified.

The assembly 100 may include a housing 14a, a plurality of leg assemblies 16, one or more beams 18, one or more brackets 20a, a grid 22a, and one or more conduits 24. The housing 14a may include a plurality of walls 28. For example, in some implementations, the housing 14a includes the first wall 28-1, the second wall 28-2, one or more third wall 28-3, and one or more fourth wall 28-4. The first wall 28-1 may be opposite the second wall 28-2. In some implementations, the first wall 28-1 and the second wall 28-2 extend in the first direction X such that the first wall is substantially (e.g., +/−10 degrees) parallel to the second wall. The third wall 28-3 and the fourth wall 28-4 may each extend in a second direction Y between the first wall 28-1 and the second wall 28-2. In some implementations, the second direction Y is substantially (e.g., +/−10 degrees) perpendicular to the first direction X such that the third wall 28-3 is substantially parallel to the fourth wall 28-4.

While the housing 14a is generally shown and described as including twelve walls 28, it will be appreciated that the housing 14a may include more or less than twelve walls 28 within the scope of the present disclosure. The walls 28 may substantially define a rectangular cylinder defining a chamber 40a in fluid communication with an upper opening 36a and a lower opening 38a. In this regard, each wall 28 may be coupled to one or more adjacent walls 28 and surround the chamber 40.

In some implementations, the assembly 100 includes eight leg assemblies 16. For example, the assembly 100 may include a first leg assembly 16-1, a second leg assembly 16-2, a third leg assembly 16-3, and a fourth leg assembly 16-4. The first leg assembly 16-1 may be coupled to the first wall 28-1 and/or one of the fourth walls 28-4. The second leg assembly 16-2 may be coupled to the first wall 28-1 and/or one of the third walls 28-3. The third and/or fourth leg assembly 16-3, 16-4 may be coupled to one or more of the third walls 28-3. The fifth leg assembly 16-4 may be coupled to the second wall 28-2 and/or one of the third walls 28-3. The sixth leg assembly 16-6 may be coupled to the second wall 28-2 and/or one of the fourth walls 28-4. The seventh and/or eighth leg assembly 16-7, 16-8 may be coupled to one or more of the fourth walls 28-4. Alternatively, the leg assemblies 16 may be coupled to the grid 22a.

As illustrated, in some implementations the assembly 100 includes a plurality of the beams 18, each extending in the first direction X between one of the third walls 28-3 and one of the fourth walls 28-4. The brackets 20a may be disposed within the chamber 40a and include a first plate 56a, a second plate 58a, and one or more supports 59. The second plate 58a may oppose the first plate 56a such that the first and second plates 56, 58 are disposed in a substantially parallel relationship extending in the first and second directions X, Y and separated from one another in the third direction Z. In this regard, the supports 59 (e.g., legs) may extend in the third direction Z and be coupled to the first and second plates 56, 58 to maintain the separation therebetween. Each of the first and second plates 56a, 58a may define one or more apertures 60a therethrough.

The bracket(s) 20a may be coupled to one or more of the beams 18. In some implementations, the bracket 20a may be movably (e.g., translatably) coupled to one or more of the beams 18 such that a location of the bracket 20a within the chamber 40a can be changed by moving (e.g., sliding) the bracket 20a relative to the beams 18

The grid 22a may be disposed within the chamber 40a and include one or more frame members 64 (e.g., wires, rods, etc.). As illustrated, one or more of the frame members 64 may extend in each of the first, second, and/or third directions X, Y, Z. In some implementations, the grid 22a (e.g., one or more of the frame members 64) is coupled to one or more of the beams 18 (e.g., the first, second, third, and/or fourth beams 18-1, 18-2, 18-3, 18-4) and/or the bracket 20a. In particular, the grid 22a may be coupled to the bracket 20a such that a location of the bracket 20a within the chamber 40a can be changed by moving (e.g., sliding) the grid 22a and the bracket 20a relative to the beams 18

As illustrated, the conduits 24 may extend (i) between (relative to the third direction Z) the foot 46 and the lower edge 34 of the walls 28, (ii) through the chamber 40a and the aperture(s) 60, and (iii) through the upper opening 36. As will be explained in more detail below, during installation of the assembly 100, wires (not shown) and cables for transmitting electricity, signals, etc. may be routed through the conduits 24 to the charging station 12.

A method of using the charging station installation assembly 10, 10a, 100 will now be described with reference to FIGS. 1 and 5. In one step of the method, the assembly 10, 100 may be placed within a hole 200 or other similar recess formed in the ground 202 such that one or more of the feet 46 engage the ground 202 within the hole 200. In another step of the method, one or more conduits (e.g., conduits 24), wires, cables, etc. may be routed through the aperture(s) 60, 60a. For example, the one or more wires, cables, etc. may be routed through the conduit(s) 24 disposed within the aperture(s) 60, 60a. In another step of the method, the assembly 10, 100 may be leveled such that the first and/or second plates 56, 56a and 58, 58a are each disposed within parallel planes (e.g., planes extending in the first and second directions X, Y). For example, one or more of the feet 46 may be moved in the third direction Z in the manner previously described in order to change the location of the feet 46 relative to the corresponding leg 44 in order to locate the plates 56, 56a and 58, 58a in respective parallel planes. In some implementations, one or more of the feet 46 are moved in the third direction Z in the manner previously described until the plates 56, 56a and 58, 58a are in planes disposed substantially (e.g., +/−10 degrees) parallel to the ground 202.

The configuration of the assembly 10, 10a, 100 described herein can allow a user to quickly and efficiently install a charging station 12 by allowing the user to ensure that the conduits 24 and/or the wires, cables, etc. disposed within the apertures 60, 60a extend in a desired direction relative to the ground 202 and/or the charging station 12.

The following Clauses provide an exemplary configuration for an apparatus for constructing a charging station, as described above.

Clause 1: An apparatus for constructing a charging station comprises a first wall; a second wall opposing the first wall; a first beam coupled to the first wall and the second wall; a grid supported by the first beam; a bracket coupled to the first beam and defining a first aperture; a first conduit extending through the first aperture; a first leg assembly coupled to the first wall or the grid, the first leg assembly including a first leg and a first foot translatably-coupled to the first leg; and a second leg assembly coupled to the second wall or the grid.

Clause 2: The apparatus of clause 1, wherein the first leg assembly includes a first plate coupled to the first leg.

Clause 3: The apparatus of clause 2, wherein the first leg assembly includes a first connector coupled to the first foot and the first leg.

Clause 4: The apparatus of clause 3, wherein the first plate defines a second aperture, and wherein the first connector is translatably-disposed within the second aperture.

Clause 5: The apparatus of any of clauses 3 through 4, wherein the first connector is threadably-coupled to the first plate.

Clause 6: The apparatus of clause 5, wherein the first connector is rotatably-coupled to the first foot.

Clause 7: The apparatus of any of clauses 1 through 6, wherein the grid includes a plurality of first members extending in a first direction; a plurality of second members extending in a second direction transverse to the first direction; and a plurality of third members extending in a third direction transverse to the first direction and the second direction.

Clause 8: The apparatus of clause 7, wherein the grid is translatably-coupled to the first beam.

Clause 9: The apparatus of any of clauses 1 through 8, further comprising a third wall coupled to the first wall and the second wall, wherein the first wall and the second wall extend in a first direction, and the third wall extends in a second direction transverse to the first direction.

Clause 10: The apparatus of clause 9, further comprising a second beam coupled to the third wall, wherein the first beam extends in the second direction, and the second beam extends in the first direction.

Clause 11: The apparatus of clause 10, wherein: the grid includes a plurality of first members and a plurality of second members, the first members extend in the first direction, and the second members extend in the second direction.

Clause 12: The apparatus of clause 11, wherein the grid is translatably-coupled to the first beam or the second beam.

Clause 13: The apparatus of any of clauses 1 through 12, wherein the bracket includes a first plate and a second plate opposing the first plate, the first plate defining the first aperture, the second plate defining a second aperture, and wherein the first conduit extends through the second aperture.

Clause 14: The apparatus of any of clauses 1 through 13, wherein the second leg assembly includes a second leg and a second foot translatably-coupled to the second leg.

Clause 15: An apparatus for constructing a charging station, the apparatus comprising: a housing including a first wall and a second wall coupled to the first wall; a first beam coupled to the first wall; a grid supported by the first beam; a bracket coupled to the first beam and defining a first aperture; a first conduit extending through the first aperture; a first leg assembly coupled to the first wall or the grid, the first leg assembly including a first leg and a first foot translatably-coupled to the first leg; and a second leg assembly coupled to the second wall or the grid.

Clause 16: The apparatus of clause 15, wherein the first leg assembly includes a first plate coupled to the first leg.

Clause 17: The apparatus of clause 16, wherein the first leg assembly includes a first connector coupled to the first foot and the first leg.

Clause 18: The apparatus of clause 17, wherein the first plate defines a second aperture, and wherein the first connector is translatably-disposed within the second aperture.

Clause 19: The apparatus of clause 18, wherein the first connector is threadably-coupled to the first plate.

Clause 20: The apparatus of clause 19, wherein the first connector is rotatably-coupled to the first foot.

Clause 21: The apparatus of any of clauses 15 through 20, wherein the grid includes: a plurality of first members extending in a first direction; a plurality of second members extending in a second direction transverse to the first direction; and a plurality of third members extending in a third direction transverse to the first direction and the second direction.

Clause 22: The apparatus of clause 21, wherein the grid is translatably-coupled to the first beam.

Clause 23: The apparatus of any of clauses 15 through 22, further comprising a third wall coupled to the second wall, wherein the first wall and the third wall extend in a first direction, and the second wall extends in a second direction transverse to the first direction.

Clause 24: The apparatus of clause 23, further comprising a second beam coupled to the second wall, wherein the first beam extends in the second direction, and the second beam extends in the first direction.

Clause 25: The apparatus of clause 24, wherein: the grid includes a plurality of first members and a plurality of second members, the first members extend in the first direction, and the second members extend in the second direction.

Clause 26: The apparatus of clause 25, wherein the grid is translatably-coupled to the first beam or the second beam.

Clause 27: The apparatus of any of clauses 15 through 26, wherein the bracket includes a first plate and a second plate opposing the first plate, the first plate defining the first aperture, the second plate defining a second aperture, and wherein the first conduit extends through the second aperture.

Clause 28: The apparatus of any of clauses 15 through 27, wherein the second leg assembly includes a second leg and a second foot translatably-coupled to the second leg.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. An apparatus for constructing a charging station, the apparatus comprising:
a first wall;
a second wall opposing the first wall;
a first beam coupled to the first wall and the second wall;
a grid supported by the first beam;
a bracket coupled to the first beam and defining a first aperture;
a first conduit extending through the first aperture;
a first leg assembly coupled to the first wall or the grid, the first leg assembly including a first leg and a first foot translatably-coupled to the first leg; and
a second leg assembly coupled to the second wall or the grid.

2. The apparatus of claim 1, wherein the first leg assembly includes a first plate coupled to the first leg.

3. The apparatus of claim 2, wherein the first leg assembly includes a first connector coupled to the first foot and the first leg.

4. The apparatus of claim 3, wherein the first connector is translatably-disposed within the first plate.

5. The apparatus of claim 4, wherein the first connector is rotatably-coupled to the first foot.

6. The apparatus of claim 1, wherein the grid includes:
a plurality of first members extending in a first direction;
a plurality of second members extending in a second direction transverse to the first direction; and
a plurality of third members extending in a third direction transverse to the first direction and the second direction.

7. The apparatus of claim 1, wherein the grid is translatably-coupled to the first beam.

8. The apparatus of claim 1, further comprising a third wall coupled to the first wall and the second wall, wherein the first wall and the second wall extend in a first direction, and the third wall extends in a second direction transverse to the first direction.

9. The apparatus of claim 8, further comprising a second beam coupled to the third wall, wherein the first beam extends in the second direction, and the second beam extends in the first direction.

10. The apparatus of claim 1, wherein the bracket includes a first plate and a second plate opposing the first plate, the first plate defining the first aperture, the second plate defining a second aperture, and wherein the first conduit extends through the second aperture.

11. The apparatus of claim 1, wherein the second leg assembly includes a second leg and a second foot translatably-coupled to the second leg.

12. An apparatus for constructing a charging station, the apparatus comprising:
a housing including a first wall and a second wall coupled to the first wall;
a first beam coupled to the first wall;
a grid supported by the first beam;
a bracket coupled to the first beam and defining a first aperture;
a first conduit extending through the first aperture;
a first leg assembly coupled to the first wall or the grid, the first leg assembly including a first leg and a first foot translatably-coupled to the first leg; and
a second leg assembly coupled to the second wall or the grid.

13. The apparatus of claim 12, wherein the first leg assembly includes a first plate coupled to the first leg.

14. The apparatus of claim 13, wherein the first leg assembly includes a first connector coupled to the first foot and the first leg.

15. The apparatus of claim 14, wherein the first connector is translatably-disposed within the first plate.

16. The apparatus of claim 12, wherein the grid includes:
a plurality of first members extending in a first direction;
a plurality of second members extending in a second direction transverse to the first direction; and
a plurality of third members extending in a third direction transverse to the first direction and the second direction.

17. The apparatus of claim 12, wherein the grid is translatably-coupled to the first beam.

18. The apparatus of claim 12, further comprising a third wall coupled to the second wall, wherein the first wall and the third wall extend in a first direction, and the second wall extends in a second direction transverse to the first direction.

19. The apparatus of claim 18, further comprising a second beam coupled to the second wall, wherein the first beam extends in the second direction, and the second beam extends in the first direction.

20. The apparatus of claim 12, wherein the bracket includes a first plate and a second plate opposing the first plate, the first plate defining the first aperture, the second plate defining a second aperture, and wherein the first conduit extends through the second aperture.
